(19) United States
(12) Patent Application Publication
(10) Pub. No.: US 2005/0027907 A1
(43) Pub. Date: Feb. 3, 2005

(54) Method and apparatus for synchronizing timeout values between host and scanning device

(75) Inventors: Kang-hoon Lee, Gyeonggi-do (KR); Eun-ok Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/895,950

(22) Filed: Jul. 22, 2004

(30) Foreign Application Priority Data
Jul. 29, 2003 (KR) 2003-52461

(51) Int. Cl. G06F 13/10

(52) U.S. Cl. 710/58

(57) ABSTRACT

A method and apparatus for synchronizing timeout values between a host and a scanning device are disclosed. The method comprises: transmitting a wait timeout value, representing a maximum time allowed for the host to receive a signal from the scanning device in response to a scanning request signal, and a job timeout value, representing a maximum time allowed for the scanning device to perform a task in response to the scanning request signal, from the scanning device to the host; and changing the wait timeout value or the job timeout value transmitted from the scanning device to the host and transmitting the changed wait timeout value or the changed job timeout value from the host to the scanning device. According to the present invention, different timeout values of the host and the scanning device are simply and rapidly synchronized.

### CROSS-REFERENCE TO RELATED APPLICATION

This application claims the priority of Korean Patent Application No. 2003-52461, filed on Jul. 29, 2003, in the Korean Intellectual Property Office, the disclosure of which is incorporated herein in its entirety by reference.

### BACKGROUND OF THE INVENTION

1. Field of the Invention

The present invention relates to a method of controlling a scanning job performed in a host connected to a scanning device, and more particularly, to a method and apparatus to synchronize timeout values between a host and a scanning device, which synchronize timeout values of a control command transmitted between the host and the scanning device.

2. Description of the Related Art

Firmware programs of a scanning driver of a host and a scanning device have a wait timeout value and a job timeout value.

The wait timeout value represents a maximum time allowed in which a reply signal, in response to a scanning request signal, is to be transmitted from the host to the scanning device. That is, the wait timeout value stored in an input/output driver of an interface unit in the host is a maximum time allowed for the host to receive a reply signal from the scanning request signal, which signals that the scanning device has normally received the scanning request. If the host receives the reply signal from the scanning device within a time equivalent to the wait timeout value, the host transmits a detailed command to the scanning device, and a scanning job is performed in the scanning device according to the detailed command. However, if the host does not receive the reply signal from the scanning device within a time equivalent to the wait timeout value, a scanning driver of the host indicates an error and the host returns to an initial state.

The job timeout value represents a maximum time allowed to perform a detailed job related to the scanning request signal. If the host receives the reply signal from the scanning device within the time equivalent to the wait timeout value, the host transmits detailed control commands, such as an inquiry command, a set window command, or a read command, within a time equivalent to the job timeout value to the scanning device one by one. However, if the host does not receive a reply signal in response to one of the detailed control commands from the scanning device within the time equivalent to the job timeout value, the scanning driver of the host indicates an error and the host returns to the initial state.

In conventional devices, each of the wait timeout value and the job timeout value are fixed in the host and the scanning device. Therefore, an efficient scanning job cannot be performed if there exists a difference between the wait timeout value and the job timeout value of the host and those of the scanning device.

The greater a difference in performance between the host and the scanning device, the lower a scanning job efficiency. To resolve the difference between the wait timeout value and the job timeout value of the host and those of the scanning device, a troublesome tuning operation must be performed. Also, even if a proper tuning operation to resolve the differences between the wait timeout value and the job timeout value of the host and those of the scanning device has been performed, in order to perform a scanning job with another host or another scanning device, a new tuning operation must be performed.

### SUMMARY OF THE INVENTION

The present invention provides a method of synchronizing timeout values between a host and a scanning device by transferring a wait timeout value and a job timeout value from the scanning device to the host, storing the wait timeout value and the job timeout value in the host, changing the wait timeout value and the job timeout value according to a request, and transmitting the changed wait timeout value and the changed job timeout value to the scanning device.

The present invention also provides an apparatus to synchronize timeout values between a host and a scanning device adopting the above-described method.

According to an aspect of the present invention, a method of synchronizing timeout values between a scanning device and a host comprising an interface unit, which controls data communication between the host and the scanning device, which is performed in the host connected to the scanning device scanning an image, comprises transmitting a wait timeout value, representing a maximum time allowed for the host to receive a signal from the scanning device in response to a scanning request signal, and a job timeout value, representing a maximum time allowed for the scanning device to perform a task in response to the scanning request signal, from the scanning device to the host, and changing the wait timeout value or the job timeout value transmitted from the scanning device to the host and transmitting the changed wait timeout value or the changed job timeout value from the host to the scanning device.

According to another aspect of the present invention, an apparatus that synchronizes timeout values between a host and a scanning device, the apparatus included in the host, which is connected to the scanning device, comprises a timeout value receiver, which requests a wait timeout value, representing a maximum time allowed for the host to receive a signal from the scanning device in response to a scanning request signal, and a job timeout value, representing a maximum time allowed for the scanning device to perform a task in response to the scanning request signal, from the scanning device and controls how the wait timeout value and the job timeout value received from the scanning device are stored; a timeout value transmitter, which transmits a changed wait timeout value or a changed job timeout value to the scanning device; and an interface unit, which controls data communication between the host and the scanning device.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIG. 1 is a flowchart illustrating a method of synchronizing timeout values between a host and a scanning device according to an exemplary embodiment of the present invention;

FIG. 2 is a detailed flowchart illustrating a operation 10 of FIG. 1;

FIG. 3 is a detailed flowchart illustrating a operation 12 of FIG. 1;

FIG. 4 is a detailed flowchart illustrating an alternative operation 12 of FIG. 1;

FIG. 5 is a block diagram of an apparatus that synchronizes timeout values between a host and a scanning device according to an exemplary embodiment of the present invention;

FIG. 6 is a block diagram of a timeout value receiver of FIG. 5;

FIG. 7 is a block diagram of a timeout value transmitter of FIG. 5; and

FIG. 8 is a block diagram of an alternative timeout value transmitter of FIG. 5.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

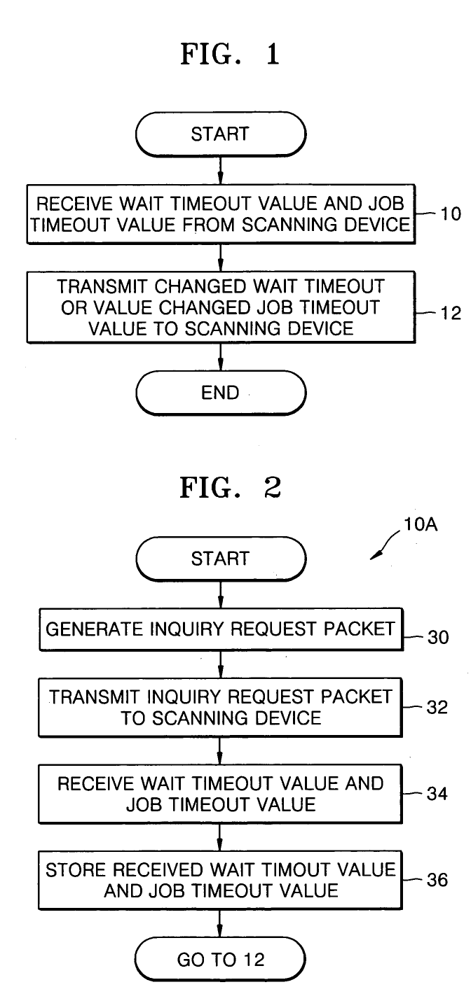

FIG. 1 is a flowchart illustrating a method of synchronizing timeout values between a host and a scanning device according to an exemplary embodiment of the present invention.

Referring to FIG. 1, in operation 10, a wait timeout value representing a maximum time allowed for a response to a scanning request signal to be received and a job timeout value representing a maximum time allowed to perform a detailed job after the scanning request signal is sent are transmitted from the scanning device. The scanning request signal requests that a scanning job is performed on an image. The scanning request signal is input by a user via an input device of the host. The wait timeout value and the job timeout value are stored in the scanning device in advance and transmitted from the scanning device to the host in response to the scanning request signal.

FIG. 2 is a detailed flowchart to illustrate an alternative operation 10A to operation 10 of FIG. 1.

Referring to FIG. 2, in operation 30, an inquiry request packet requesting a wait timeout value and a job timeout value along with additional information is generated. The inquiry request packet is control command data that the host transmits to request various information regarding a scanning job stored in the scanning device.

In operation 32, the inquiry request packet is transmitted to the scanning device.

In operation 34, the wait timeout value and the job timeout value along with the additional requested information are transmitted from the scanning device to the host in response to the inquiry request packet.

In operation 36, the received wait timeout value and job timeout value are stored in a predetermined storage area in the host.

After the wait timeout value and the job timeout value of the scanning device are stored in the host, the host and the scanning device have the same wait timeout value and job timeout value. Therefore, since synchronization of the timeout values of the host and the scanning device is automatically performed, a separated tuning an operation to synchronize the timeout values of the host and the scanning device is not required.

In operation 12, if the wait timeout value or the job timeout value may be changed in response to a user's request, the changed wait timeout value or the changed job timeout value is transmitted to the scanning device and used as a new wait timeout value or a new job timeout value of the scanning device.

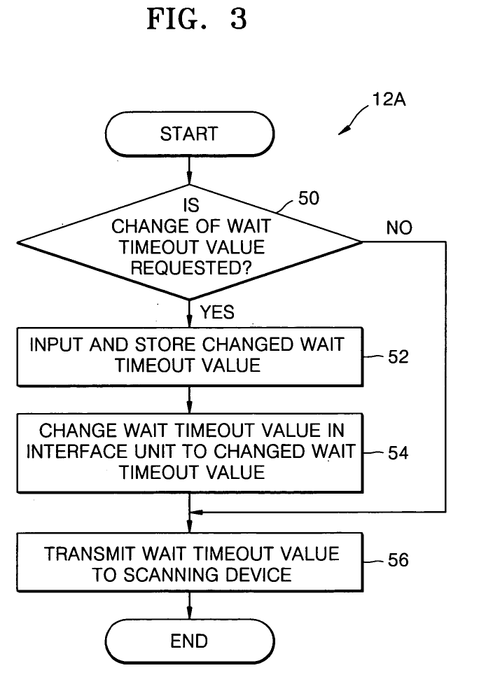

FIG. 3 is a detailed flowchart illustrating an alternative operation 12A to 12 of FIG. 1.

Referring to FIG. 3, in operation 50, whether a change of the received wait timeout value is determined to have been requested.

If a change of the received wait timeout value is determined to have been requested, the changed wait timeout value is input and stored in the predetermined storage area of the host in operation 52.

In operation 54, a wait timeout value preset in an interface unit controlling data communication between the host and the scanning device is set to the changed wait timeout value. The interface unit included in the host includes an input/output driver that controls data communication between the host and the scanning device. The interface unit stores a wait timeout value and senses whether a response to a scanning request signal from the scanning device is received within a time equivalent to the wait timeout value. If the reply signal is not received within the time equivalent to the wait timeout value, the interface unit indicates an error to the host and initializes the host. If the changed wait timeout value is stored in the host in operation 52, the wait timeout value preset in the interface unit is set to the changed wait timeout value in operation 54.

If a change of the received wait timeout value is determined to have not been requested in operation 50, or if the wait timeout value preset in the interface unit is set to the changed wait timeout value in operation 54, the unchanged wait timeout value or the changed wait timeout value is transmitted to the scanning device in operation 56.

The wait timeout value transmitted to the scanning device is stored in a predetermined storage area of the scanning device. An existing wait timeout value stored in the scanning device is replaced by the changed wait timeout value.

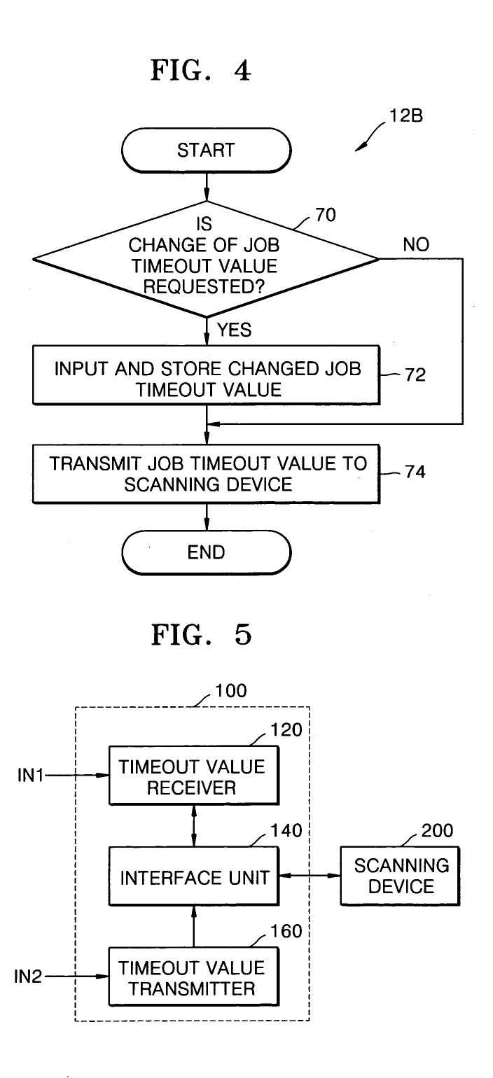

FIG. 4 is a detailed flowchart illustrating an alternative operation 12 of FIG. 1.

In operation 70, whether a user has requested a change of the job timeout value is determined.

If a change of the received job timeout value is determined to have been requested, the changed job timeout value is input and stored in the predetermined storage area of the host in operation 72.

If a change of the received job timeout value is determined to have not been requested in operation 70, or if the changed job timeout value is stored in the host in operation 72, the unchanged job timeout value or the changed job timeout value is transmitted to the scanning device in operation 74.

The job timeout value transmitted to the scanning device is stored in a predetermined storage area of the scanning device. An existing job timeout value stored in the scanning device is replaced by the changed job timeout value.

Hereinafter, an apparatus that synchronizes timeout values between a host and a scanning device according to an exemplary embodiment of the present invention will now be described.

FIG. 5 is a block diagram of an apparatus that synchronizes timeout values between a host and a scanning device according to an exemplary embodiment of the present invention. The apparatus includes a timeout value receiver 120, an interface unit 140, and a timeout value transmitter 160.

The timeout value receiver 120 receives a scanning request signal via an input terminal IN1 and requests a wait timeout value and a job timeout value of the input scanning request signal from the scanning device 200. The timeout value receiver 120 receives the wait timeout value and the job timeout value from the scanning device 200 and controls storage of the received wait timeout value and job timeout value in a predetermined storage area of the host 100.

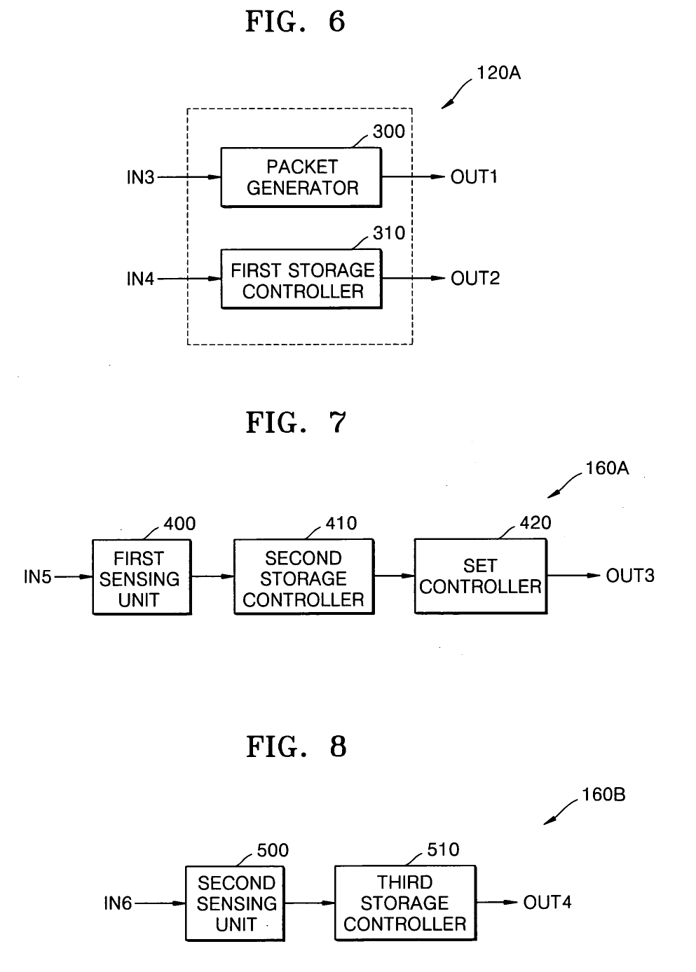

FIG. 6 is a block diagram of the timeout value receiver 120 of FIG. 5.

A packet generator 300 receives a scanning request signal via an input terminal IN3, generates an inquiry request packet corresponding to a request signal requesting various types of information which may be necessary for a scanning job including the wait timeout value and the job timeout value, and outputs the generated inquiry request packet via an output terminal OUT1. The inquiry request packet output via the output terminal OUT1 is received by the scanning device 200 via the interface unit 140.

A first storage controller 310 receives the wait timeout value and the job timeout value requested from the scanning device 200 by the inquiry request packet via an input terminal IN4 and the interface unit 140. The first storage controller 310 controls the host 100 to store the received wait timeout value and job timeout value in the predetermined storage area of the host 100 and outputs a control signal via an output terminal OUT2.

The interface unit 140 controls data communication between the host 100 and the scanning device 200. The interface unit 140 controls data communication of the wait timeout value and the job timeout value according to the method of the present invention as well as data communication of general data. In particular, the interface unit 140 stores a wait timeout value and senses whether a reply signal is received from the scanning device 200 in response to a scanning request signal output by the host 100 within a time equivalent to the wait timeout value. If the reply signal is not received within the time equivalent to the wait timeout value, the interface unit 140 indicates an error to the host 100 and initializes the host 100.

The timeout value transmitter 160 receives a changed wait timeout value or a changed job timeout value via an input terminal IN2 and transmits the changed wait timeout value or the changed job timeout value to the scanning device 200 via the interface unit 140.

FIG. 7 is a block diagram of the timeout value transmitter of FIG. 5. The timeout value transmitter 160A includes a first sensing unit 400, a second storage controller 410, and a set controller 420.

The first sensing unit 400 senses whether a changed wait timeout value is input by the user via an input terminal IN5 and outputs the sensing result as a first sensing signal to the second storage controller 410.

The second storage controller 410 controls the host 100 to store the changed wait timeout value in the predetermined storage area in response to the first sensing signal received from the first sensing unit 400 by outputting a second control signal to the set controller 420.

The set controller 420 controls the host 100 to change the wait timeout value in the interface unit 140 to the changed wait timeout value in response to the second control signal received from the second storage controller 410 by outputting a set signal to the interface unit 140 via an output terminal OUT3. The changed wait timeout value is transmitted to the scanning device 200 via the interface unit 140 and stored in the scanning device 200. The interface unit 140 senses whether a reply signal is received from the scanning device 200 in response to a scanning request signal within a time equivalent to the changed wait timeout value. If the reply signal is not received within the time equivalent to the newly set wait timeout value, the interface unit 140 indicates an error to the host 100 and initializes the host 100.

FIG. 8 is a block diagram of an alternative timeout value transmitter of FIG. 5. The timeout value transmitter 160B includes a second sensing unit 500 and a third storage controller 510.

The second sensing unit 500 senses whether a changed job timeout value is input by the user via an input terminal IN6 and outputs the sensing result as a second sensing signal to the third storage controller 510.

The third storage controller 510 controls the host 100 to store the changed job timeout value in the predetermined storage area in response to the second sensing signal received from the second sensing unit 500 by outputting a third control signal via an output terminal OUT4. The job timeout value output via the output terminal OUT4 is transmitted to the scanning device 200 via the interface unit 140 and stored in the scanning device 200.

As is described above, since the method receives timeout values automatically received from the scanning device and changed timeout values received from a user are transmitted to the scanning device, different timeout values of the host and the scanning device are simply and rapidly synchronized.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of synchronizing timeout values between a scanning device and a host including an interface unit, which controls data communication that occurs between the host and the scanning device when the host is connected to the scanning device scanning an image, the method comprising:
transmitting a wait timeout value, representing a maximum time allowed for the host to receive a signal from the scanning device in response to a scanning request signal, and a job timeout value, representing a maximum time allowed for the scanning device to perform a task in response to the scanning request signal, from the scanning device to the host; and
changing the wait timeout value or the job timeout value transmitted from the scanning device to the host and transmitting the changed wait timeout value or the changed job timeout value from the host to the scanning device.

2. The method of claim 1, further comprising storing the wait timeout value and the job timeout value in the scanning device in advance.

3. The method of claim 2, wherein the transmitting a wait timeout value comprises generating an inquiry request packet in the host requesting the wait timeout value and the job timeout value.

4. The method of claim 3, wherein the transmitting a wait timeout value further comprises transmitting the inquiry request packet from the host to the scanning device.

5. The method of claim 4, wherein the transmitting a wait timeout value further comprises receiving the wait timeout value and the job timeout value from the scanning device.

6. The method according to claim 5, wherein the transmitting a wait timeout value further comprises storing the received wait timeout value and the received job timeout value.

7. The method of claim 6, wherein the changing and transmitting comprises: determining whether a change of the wait timeout value is requested.

8. The method of claim 7, wherein the changing and transmitting further comprises inputting and storing a changed wait timeout value in the host if a change of the wait timeout value is requested.

9. The method of claim 8, wherein the changing and transmitting further comprises changing a wait timeout value in the interface unit to the changed wait timeout value.

10. The method of claim 9, wherein the changing and transmitting further comprises transmitting the wait timeout value stored in the interface unit to the scanning device.

11. The method of claim 10, further comprising storing the transmitted wait timeout value in the scanning device.

12. The method of claim 11, wherein the changing and transmitting comprises determining whether a change of the job timeout value is requested.

13. The method of claim 12, wherein the changing and transmitting further comprises inputting and storing a changed job timeout value in the host if a change of the job timeout value is determined to have been requested.

14. The method of claim 13, wherein the changing and transmitting further comprises transmitting the job timeout value stored in the host to the scanning device.

15. The method of claim 14, further comprising storing the transmitted job timeout value in the scanning device.

16. An apparatus that synchronizes timeout values between a host and a scanning device, which is connected to the host, the apparatus comprising:
a timeout value receiver, to request:
a wait timeout value, representing a maximum time allowed for the host to receive a signal from the scanning device in response to a scanning request signal, and
a job timeout value, representing a maximum time allowed for the scanning device to perform a task in response to the scanning request signal, from the scanning device, to control how the wait timeout value and the job timeout value received from the scanning device are stored;
a timeout value transmitter, to transmit a changed wait timeout value or a changed job timeout value to the scanning device; and
an interface unit, to control data communication between the host and the scanning device.

17. The apparatus of claim 16, wherein the timeout value receiver initially requests the wait timeout value and the job timeout value previously stored in the scanning device.

18. The apparatus of claim 17, wherein the timeout value receiver comprises
a packet generator, to generate an inquiry request packet requesting the wait timeout value and the job timeout value and to output the generated inquiry request packet to the scanning device via the interface unit.

19. The apparatus of claim 18, wherein the timeout value receiver further comprises a first storage controller, to receive the wait timeout value and the job timeout value requested from the scanning device by the inquiry request packet via the interface unit and control storage of the wait timeout value and the job timeout value in a predetermined storage area of the host.

20. The apparatus of claim 19, wherein the timeout value transmitter further comprises a first sensing unit, to sense whether a change of the wait timeout value is requested and to output the sensing result as a first sensing signal.

21. The apparatus of claim 20, wherein the timeout value transmitter further comprises a second storage controller, to control storage of a changed wait timeout value in response to the first sensing signal.

22. The apparatus of claim 21, wherein the timeout value transmitter further comprises a set controller, to control the host to change the wait timeout value in the interface unit to the changed wait timeout value.

23. The apparatus of claim 22, wherein the wait timeout value stored in the interface unit is transmitted to the scanning device and is stored in the scanning device.

24. The apparatus of claim 23, wherein the timeout value transmitter further comprises a second sensing unit, to sense whether a change of the job timeout value is requested and to output the sensing result as a second sensing signal.

25. The apparatus of claim 24, wherein the timeout value transmitter further comprises a third storage controller, to control storage of a changed job timeout value in response to the second sensing signal.

26. The apparatus of claim 25, wherein the job timeout value stored in the interface unit is transmitted to the scanning device and stored in the scanning device.

27. A method of synchronizing timeout values between a scanning device and a host including an interface unit, which controls data communication, performed in the host connected to the scanning device scanning an image, between the host and the scanning device, the method comprising:
transmitting a wait timeout value, equal to a maximum time allowed for the host to receive a signal from the scanning device in response to a scanning request signal, from the scanning device to the host;
transmitting a job timeout value, representing a maximum time allowed for the scanning device to perform a task in response to the scanning request signal, from the scanning device to the host; and
changing the wait timeout value or the job timeout value transmitted from the scanning device to the host and transmitting the changed wait timeout value or the changed job timeout value from the host to the scanning device.

28. An apparatus that synchronizes timeout values between a host, in which the apparatus is included, and a scanning device, which is included in and connected to the host, the host including an interface unit, the apparatus comprising:
a timeout value receiver, to request:
a wait timeout value, representing a maximum time for the host to receive a signal from the scanning device in response to a scanning request signal, and
a job timeout value, representing a maximum time for the scanning device to perform a task in response to the scanning request signal, from the scanning device, to control a storage of the wait timeout value and the job timeout value; and
a timeout value transmitter, to determine whether the wait timeout value and the job timeout value need to be changed, to accomplish the change, and to transmit the changed wait timeout value or a changed job timeout value to the scanning device.
